(19) United States
(12) Patent Application Publication
(10) Pub. No.: US 2024/0009609 A1
(43) Pub. Date: Jan. 11, 2024

(54) WASHABLE FILTER BODIES AND METHODS FOR PRODUCING

(71) Applicant: CORNING INCORPORATED, CORNING, NY (US)

(72) Inventors: Guisong Lu, Shanghai (CN); He Wang, Shanghai (CN); Huiqing Wu, Shanghai (CN)

(21) Appl. No.: 18/039,577

(22) PCT Filed: Dec. 1, 2020
(86) PCT No.: PCT/CN2020/133021

§ 371 Date: May 31, 2023

(51) Int. Cl. B01D 46/24; B01D 39/20; C04B 38/00; B01J 37/02

(52) U.S. Cl. CPC B01D 46/2429; B01D 39/201; B01D 39/2075; B01D 39/2079; C04B 38/0009; B01J 37/0215; B01D 2239/0485; B01D 2239/086; B01D 2239/10; B01D 2239/1208; B01D 2239/1216; B01D 2239/1241; B01D 2239/125; B01D 2273/30; C04B 2111/00793

(57) ABSTRACT

A filtration article is disclosed comprising a plugged porous honeycomb filter body, deposits of inorganic particles within the plugged honeycomb filter body, the deposits having a porosity in a range of greater than 95% to less than or equal to 99.9% and an average thickness in a range of greater than or equal to 0.5 μm to less than or equal to 200 μm, and at least some of the inorganic particles being fused to each other and/or to the filter body. The particles are fused by one or more of low-melting inorganic particles, inorganic particles capable of chemical bonding organic fusion bonds or organic chemical bonds between inorganic particles coated with an organic binder.

### TECHNICAL FIELD

The current disclosure relates to washable air particulate filter bodies particularly to honeycomb bodies having washable deposits of inorganic particles thereon which are at least in part fused to each other and/or to the filter body, and to methods for producing such filter bodies.

### BACKGROUND

Air particulate filters can be used to filter particulates from the air in indoor and outdoor settings and wherever excessive particulate pollution can be present.

Air particulate filters can employ filter bodies formed of porous-walled ceramic honeycombs which can trap particulates, filtering them from the air passing through the bodies. In newly manufactured ceramic honeycomb filter bodies, filtration efficiency (measured as the percentage of particles in an airstream trapped by the filter) is low at first but increases as the filter begins to accumulate particles. There is a need for filter bodies having high as-new filtration efficiency (“clean” filtration efficiency), so that people or sensitive environments are not exposed to undesirable levels of particulate pollution at the first of use of a new filter. It is also desirable that such filter bodies can be regenerated by washing without significantly decreasing the resulting post-washing filtration efficiency relative to the as-new filtration efficiency.

### SUMMARY

One or more aspects of the disclosure are directed to a filtration article comprising a plugged honeycomb filter body, deposits of inorganic particles within the plugged honeycomb filter body, the deposits having a porosity in a range of greater than 95% to less than or equal to 99.9% and an average thickness in a range of greater than or equal to 0.5 μm to less than or equal to 200 μm, and at least some of the inorganic particles being fused to each other or to the filter body.

In some embodiments, the filtration article has a clean filtration efficiency of greater than or equal to 80% as measured by a liquid phase aerosol filtration efficiency test, and a decrease of filtration efficiency after a water flush regeneration of less than 10% measured by the liquid phase aerosol filtration efficiency test.

In some embodiments the filter body is comprised of cordierite, aluminum titanate, enstatite, mullite, forsterite, corundum, spinel, sapphirine, and periclase, or combinations thereof.

In some embodiments, the filter body is comprised of cordierite.

In some embodiments, the at least some of the inorganic particles are fused to each other or to the filter body by one or more of (1) inorganic fusion bonding between at least some of the inorganic particles by fusion bonds formed by low-melting inorganic particles constituting at least some of the inorganic particles, (2) inorganic chemical bonding between at least some of the inorganic particles by chemical bonds formed by inorganic particles capable of chemical bonding constituting at least some of the inorganic particles, and (3) organic fusion bonds or organic chemical bonds between inorganic particles with the bonds formed by an organic coating on inorganic particles constituting at least some of the inorganic particles.

In some embodiments, the inorganic particles comprise particles of low melting glass and other inorganic particles. In some embodiments, the other inorganic particles comprise mineral particles.

In some embodiments, the inorganic particles consist essentially of particles of low melting glass.

In some embodiments, the inorganic particles comprise particles of cement and other inorganic particles. In some embodiments, the other inorganic particles comprise mineral particles.

In some embodiments, the inorganic particles consist essentially of particles of cement.

In some embodiments, the inorganic particles comprise inorganic particles coated with an inorganic binder and other inorganic particles. In some embodiments, the other inorganic particles comprise mineral particles.

In some embodiments, the inorganic particles consist essentially of inorganic particles coated with an inorganic binder.

In some embodiments, the deposits disposed within the plugged honeycomb filter body are present at a loading of greater than 0.05 and less than or equal to 20 grams of the deposits per liter of the plugged honeycomb filter body.

In some embodiments, the inorganic particles comprise one or more of low melting glass particles, cement particles, binder-coated mineral particles, or combinations thereof. In some embodiments the mineral particles comprise one or more of calcium carbonate, kaoline, wollastonite, talcum powder, mica powder, silica powder, brucite powder, pyrophyllite, coal ash, dolomite, sepiolite, or combinations thereof.

In some embodiments, the mineral particles have a D50 particle size distribution falling in the range of from 10 to 600 nm, from 10 to 500 nm, or from 50 to 500 nm.

One or more additional aspects of the disclosure are directed to a method of applying inorganic particles to a plugged honeycomb body comprising intersecting porous walls extending from an inlet end to an outlet end of the body and defining axial channels, wherein some of the channels are plugged, the method comprising aerosolizing a plurality of inorganic particles having a particle d50 of between 10 nm and 500 nm, depositing the particles on, in, or both on and in, the porous walls of the plugged honeycomb body, and fusing at least some of the particles to each other and to the plugged honeycomb body.

In some embodiments, the mineral particles have a D50 particle size distribution falling in the range of from 10 to 600 nm, from 10 to 500 nm, or from 50 to 500 nm.

In some embodiments, the particles comprise one or more of low melting glass particles, cement particles, binder-coated mineral particles, or combinations thereof.

In some embodiments, the mineral particles comprise particles of calcium carbonate, kaoline, wollastonite, talcum powder, mica powder, silica powder, brucite powder, pyrophyllite, coal ash, dolomite, sepiolite, or combinations thereof.

In some embodiments, the aerosolizing comprises passing a suspension of the inorganic particles and a carrier fluid through a venturi tube.

In some embodiments, the aerosolizing generates a dry aerosol stream containing the inorganic particles.

In some embodiments, the carrier fluid is a gas.

In some embodiments, the carrier fluid is an essentially dry gas.

In some embodiments, the carrier fluid is a liquid.

In some embodiments, the carrier fluid comprises a liquid, a gas, or a combination thereof.

### BRIEF DESCRIPTION OF THE DRAWINGS

So that the manner in which the above recited features of the present disclosure can be understood in detail, a more particular description of the disclosure, briefly summarized above, can be had by reference to embodiments, some of which are illustrated in the appended drawings. It is to be noted, however, that the appended drawings illustrate only typical embodiments of this disclosure and are therefore not to be considered limiting of its scope, for the disclosure can admit to other equally effective embodiments.

FIG. 1 schematically depicts a honeycomb body;

FIG. 2 schematically depicts a wall-flow air particulate filter body according to embodiments disclosed and described herein;

FIG. 3 is a cross-sectional longitudinal view of a portion of the air particulate filter body shown in FIG. 2;

FIG. 4 schematically depicts a portion of a wall of a honeycomb body of an air particulate filter with particulate loading according to the present disclosure;

FIG. 5 schematically depicts an apparatus configured to deposit inorganic particles on a plugged honeycomb body according to an embodiment of the present disclosure;

FIG. 6 schematically depicts an aerosol generator according to an embodiment of the present disclosure;

FIG. 7 schematically depicts a Venturi tube used in an aerosol generator shown in FIG. 6 according to an embodiment of the present disclosure;

FIG. 8 is an isometric view of a portion of the aerosol generator shown in FIG. 6;

FIG. 9 is a flowchart of an exemplary embodiment of a method according to the present disclosure;

FIG. 10 is a SEM photograph of the sample prepared according to the Examples herein;

FIG. 11A-D are SEM photographs of samples prepared according to the Examples herein;

FIG. 12 is a graph showing filtration efficiency as a function of dust loading for plugged honeycomb filter body samples prepared according to one or more of the Examples;

FIGS. 13A-B are SEM photographs of samples prepared according to the Examples herein; and

FIG. 14 is a graph showing clean back pressure as a function of flow rate for samples prepared according to one or more of the Examples.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

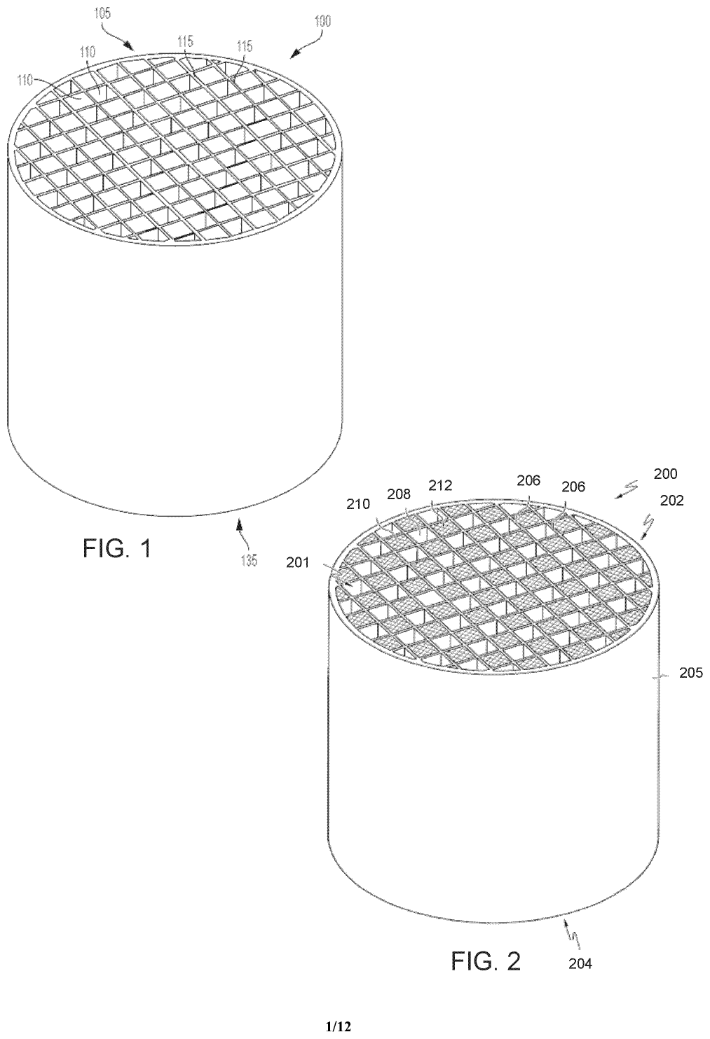

Aspect and methods of the present disclosure relate to application of inorganic particles to a plugged honeycomb body comprising porous walls. With reference to FIG. 1, a honeycomb body 100 according to one or more embodiments shown and described herein is depicted. The honeycomb body 100 can, in embodiments, comprise a plurality of walls 115 defining a plurality of inner channels 110. The plurality of inner channels 110 and intersecting channel walls 115 extend between first end 105, which can be an inlet end, and second end 135, which can be an outlet end, of the honeycomb body 100. The honeycomb body can have one or more of the channels plugged on one or both of (1) the first end 105 and (2) the second end 135, as further described below in reference to FIG. 2. The pattern of plugged channels of the honeycomb body is not limited. In some embodiments, a pattern of plugged and unplugged channels at one end of the plugged honeycomb body can be, for example, a checkerboard pattern where alternating channels of one end of the plugged honeycomb body are plugged. In some embodiments, plugged channels at one end of the plugged honeycomb body have corresponding unplugged channels at the other end, and unplugged channels at one end of the plugged honeycomb body have corresponding plugged channels at the other end.

In one or more embodiments, the plugged honeycomb body can be formed from cordierite, aluminum titanate, enstatite, mullite, forsterite, corundum (SiC), spinel, sapphirine, and periclase, and combinations thereof. In one or more embodiments, the plugged honeycomb body is formed from cordierite. In general, cordierite has a composition according to the formula Mg₂Al₄Si₅O₁₈. In some embodiments, the pore size of the ceramic material, the porosity of the ceramic material, and the pore size distribution of the ceramic material are controlled, for example by varying the particle sizes of the ceramic raw materials. In addition, pore formers can be included in ceramic batches used to form the honeycomb body to assist in producing a particular porosity.

In some embodiments, walls of the plugged honeycomb body can have an average thickness from greater than or equal to 25 μm to less than or equal to 250 μm, such as from greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm.

In one or more embodiments, the bulk of the plugged honeycomb body (prior to applying any filtration material) has a median pore size from greater than or equal to 7 μm to less than or equal to 25 μm, such as from greater than or equal to 10 μm to less than or equal to 22 μm, or from greater than or equal to 10 μm to less than or equal to 18 μm. For example, in some embodiments, the bulk of the plugged honeycomb body can have bulk median pore sizes of about 10 μm, about 11 μm, about 12 μm, about 13 μm, about 14 μm, about 15 μm, about 16 μm, about 17 μm, about 18 μm, about 19 μm, or about 20 μm. The term “median pore size” or “d50” (prior to applying any filtration material) refers to a diametrical length measurement of pores, above which the pore sizes of 50% of the pores lie and below which the pore sizes of the remaining 50% of the pores lie, based on the statistical distribution of all the pores.

In specific embodiments, the median pore size (d50) of the bulk of the plugged honeycomb body (prior to applying any filtration material) is in a range of from 10 μm to about 16 μm, for example 13-14 μm, and the d10 refers to a length measurement, above which the pore sizes of 90% of the pores lie and below which the pore sizes of the remaining 10% of the pores lie, based on the statistical distribution of all the pores is about 7 μm. In specific embodiments, the d90 refers to a length measurement, above which the pore sizes of 10% of the pores of the bulk of the plugged honeycomb body (prior to applying any filtration material) lie and below which the pore sizes of the remaining 90% of the pores lie, based on the statistical distribution of all the pores is about 30 μm. In some embodiments, the bulk of the plugged honeycomb body can have bulk porosities, not counting a coating, of from greater than or equal to 50% to less than or equal to 75% as measured by mercury intrusion porosimetry. In one or more embodiments, the bulk porosity of the plugged honeycomb body can be in a range of from about 50% to about 75%, in a range of from about 50% to about 70%, in a range of from about 50% to about 65%, in a range of from about 50% to about 60%, in a range of from about 50% to about 58%, in a range of from about 50% to about 56%, or in a range of from about 50% to about 54%, for example.

In some embodiments, the surface of the plugged honeycomb body can have surface porosities, prior to application of a filtration material deposit, of from greater than or equal to 35% to less than or equal to 75% as measured by SEM. In one or more embodiments, the surface porosity of the plugged honeycomb body can be less than 65%, such as less than 60%, less than 55%, less than 50%, less than 48%, less than 46%, less than 44%, less than 42%, less than 40%, less than 48%, or less than 36% for example.

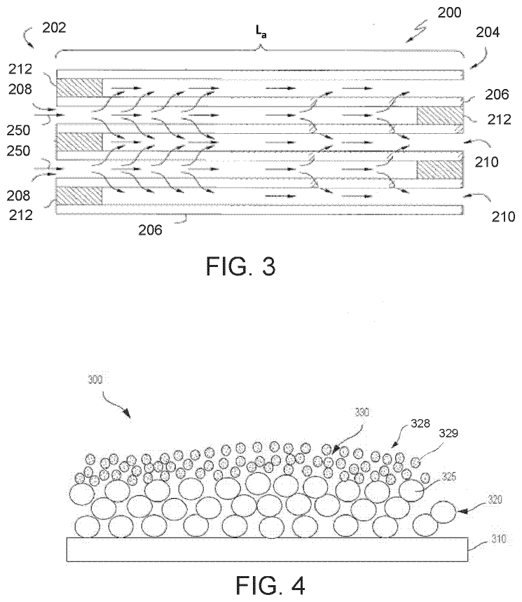

Referring now to FIGS. 2 and 3, a plugged honeycomb body, or plugged honeycomb air particulate filter (APF) body 200 is schematically depicted. The air particulate filter body 200 can be used as a wall-flow filter to filter particulate matter from an air stream 250. The particulate filter body 200 generally comprises a honeycomb body having a plurality of channels 201 or cells which extend between an inlet end 202 and an outlet end 204, defining an overall length La (shown in FIG. 3). The channels 201 of the particulate filter body 200 are formed by, and at least partially defined by a plurality of intersecting channel walls 206 that extend from the inlet end 202 to the outlet end 204. The particulate filter body 200 can also include a skin layer 205 surrounding the plurality of channels 201. This skin layer 205 can be extruded during the formation of the channel walls 206 or formed in later processing as an after-applied skin layer, such as by applying a skinning cement to the outer peripheral portion of the channels.

An axial cross section of the air particulate filter body 200 of FIG. 2 is shown in FIG. 3. In some embodiments, certain channels are designated as inlet channels 208 and certain other channels are designated as outlet channels 210. In some embodiments of the air particulate filter body 200, at least a first set of channels is plugged with plugs 212. Generally, the plugs 212 are disposed proximate the ends (i.e., the inlet end and/or the outlet end) of the channels 201. The plugs are arranged in a pre-defined pattern, such as in the checkerboard pattern shown in FIG. 2 with every other channel being plugged at an end. The inlet channels 208 can be plugged at or near the outlet end 204, and the outlet channels 210 can be plugged at or near the inlet end 202 on channels not corresponding to the inlet channels, as depicted in FIG. 3. Accordingly, each cell can be plugged at or near only one end of the particulate filter.

While FIG. 2 generally depicts a checkerboard plugging pattern, it should be understood that alternative plugging patterns can be used in the porous air particulate filter body. In the embodiments described herein, the air particulate filter body 200 can be formed with a channel density of up to about 600 channels per square inch (cpsi). For example, in some embodiments, the air particulate filter body 200 can have a channel density in a range from about 100 cpsi to about 600 cpsi. In some other embodiments, the air particulate filter body 200 can have a channel density in a range from about 100 cpsi to about 400 cpsi or even from about 200 cpsi to about 300 cpsi.

In the embodiments described herein, the channel walls 206 of the air particulate filter body 200 can have a thickness of greater than about 4 mils (101.6 micrometers). For example, in some embodiments, the thickness of the channel walls 206 can be in a range from about 4 mils up to about 30 mils (762 micrometers). In some other embodiments, the thickness of the channel walls 206 can be in a range from about 7 mils (177.8 micrometers) to about 20 mils (508 micrometers).

In some embodiments of the air particulate filter body 200 described herein the channel walls 206 of the air particulate filter body 200 can have a bare open porosity (i.e., the porosity before any coating is applied to the plugged honeycomb body) % P≥35% prior to the application of any deposit(s) to the particulate filter body 200. In some embodiments the bare open porosity of the channel walls 206 can be such that 40%≤% P≤75%. In other embodiments, the bare open porosity of the channel walls 206 can be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in some embodiments, the channel walls 206 of the air particulate filter body 200 are formed such that the pore distribution in the channel walls 206 has a median pore size of ≤30 micrometers prior to the application of any deposit(s) (i.e., bare). For example, in some embodiments, the median pore size can be ≥8 micrometers and less than or ≤30 micrometers. In other embodiments, the median pore size can be ≥10 micrometers and less than or ≤30 micrometers. In other embodiments, the median pore size can be ≥10 micrometers and less than or ≤25 micrometers. In some embodiments, it is desirable to maintain the median pore size of the channel wall in a range of from about 8 micrometers to about 30 micrometers, for example, in a range of from 10 micrometers to about 20 micrometers.

In one or more embodiments described herein, the plugged honeycomb body of the air particulate filter body 200 is formed from a metal or ceramic porous material such as, for example, cordierite, silicon carbide, aluminum oxide, aluminum titanate or any other suitable material for use in air particulate filtration applications. For example, the particulate filter body 200 can be formed from cordierite by mixing a batch of ceramic precursor materials which comprise constituent materials suitable for producing a ceramic article which when fired predominately comprises a cordierite crystalline phase. Constituent materials suitable for cordierite formation include a combination of inorganic components including talc, a silica-forming source, and an alumina-forming source. The batch mixture can additionally comprise clay, such as, for example, kaolin clay. The cordierite precursor batch composition can also contain organic components, such as organic pore formers, which are added to the batch mixture to achieve the desired pore size distribution upon firing. For example, the batch composition can comprise a starch which is suitable for use as a pore former and/or other processing aids. Alternatively, the constituent materials can comprise one or more cordierite powders suitable for forming a sintered cordierite honeycomb structure upon firing as well as an organic pore former material.

The batch composition can additionally comprise one or more processing aids such as, for example, a binder and a liquid vehicle, such as water or a suitable solvent. The processing aids can be added to the batch mixture to plasticize the batch mixture and to generally improve processing, reduce the drying time, reduce cracking upon firing, and/or aid in producing the desired properties in the resulting plugged honeycomb body. For example, the binder can include an organic binder. Suitable organic binders include water soluble cellulose ether binders such as methylcellulose, hydroxypropyl methylcellulose, methylcellulose derivatives, hydroxyethyl acrylate, polyvinylalcohol, and/or any combinations thereof. Incorporation of the organic binder into the plasticized batch composition allows the plasticized batch composition to be readily extruded. In some embodiments, the batch composition can include one or more optional forming or processing aids such as, for example, a lubricant which assists in the extrusion of the plasticized batch mixture.

After the batch of ceramic precursor materials is mixed with the appropriate processing aids, the batch of ceramic precursor materials is extruded and cut and dried to form a green honeycomb body comprising an inlet end and an outlet end with a plurality of channel walls extending between the inlet end and the outlet end. Thereafter, the green honeycomb body is fired according to a firing schedule suitable for producing a fired ceramic honeycomb body. At least a first set of the channels of the fired ceramic honeycomb body are then plugged in a predefined plugging pattern with a ceramic plugging composition. The plugs of the honeycomb body can then dried or cured, or the fired honeycomb body can be fired again to ceram (or fire) the plugs, in order to secure the plugs and seal the respective channels.

According to the present disclosure, the plugged honeycomb body constitutes or forms an air particulate filter body. Thus the median pore size, porosity, geometry and other design aspects of both the bulk and the surface pores of the plugged honeycomb body are selected and/or provided taking into account the desired filtration performance of the air particulate filter body. As shown in the embodiment of FIG. 4, walls 310 of the plugged honeycomb body 300, which represents a portion of the structure as shown in FIGS. 2 and 3, also have deposits 320 of inorganic particles 325 disposed thereon. The deposits 320 comprise inorganic particles 325 that are deposited on the wall 310 of the plugged honeycomb body 300 and help prevent particles 328 of pollutant 329, such as, for example, soot and/or ash, from exiting the plugged honeycomb body along with a gas stream 330, and to help prevent the pollutant 329 from clogging the walls 310 of the plugged honeycomb body 300. In this way, and according to embodiments herein, the deposits 320 of inorganic particle 325 can serve as a filtration component while the walls 310 of the plugged honeycomb body also filter, and can be also configured to minimize pressure drop relative to filtration performance. The deposits 320 of inorganic particles 325 can be delivered by the apparatus and deposition methods described herein.

According to the present disclosure at least some of the inorganic particles 325 of deposits 320 are fused to each other and to the plugged honeycomb body 300. This allows the plugged honeycomb body 300 or the filter body thus created to be washable, or in more specific terms, to provide a decrease of filtration efficiency after a water flush regeneration of less than 10% measured by a liquid phase aerosol filtration efficiency test, as described more specifically below.

According to embodiments, the particles 325 comprise one or more of low melting glass particles, cement particles, binder-coated mineral particles, or combinations thereof.

According to embodiments, the particles 325 are fused to each other or to the filter body 300 by one or more of (1) inorganic fusion bonding between at least some of the inorganic particles by fusion bonds formed by low-melting inorganic particles constituting at least some of the inorganic particles, (2) inorganic chemical bonding between at least some of the inorganic particles by chemical bonds formed by inorganic particles capable of chemical bonding constituting at least some of the inorganic particles, and (3) organic fusion bonds or organic chemical bonds between inorganic particles with the bonds formed by an organic coating on inorganic particles constituting at least some of the inorganic particles.

In embodiments, all of the particles 325 can be in the form of low melting glass particles, cement particles, or binder-coated mineral particles, of minerals as calcium carbonate, kaoline, wollastonite, talcum powder, mica powder, silica powder, brucite powder, pyrophyllite, coal ash, dolomite, sepiolite, or combinations thereof. Alternatively, any of low melting glass particles, cement particles, or binder-coated mineral particles may be combined with additional mineral particles of minerals as calcium carbonate, kaoline, wollastonite, talcum powder, mica powder, silica powder, brucite powder, pyrophyllite, coal ash, dolomite, sepiolite, or combinations thereof, layered in any desired way or mixed together.

The deposits disposed in and/or on walls of the plugged honeycomb body can be very thin compared to thickness of the walls 310 of the plugged honeycomb body. In some embodiments, in or on one or more portions of the walls of the honeycomb body, the average thickness of the deposits is greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm.

In one or more embodiments, the deposits have a porosity as measured by mercury intrusion porosimetry in a range of from greater than 95% to less than or equal to 99.9%, or from greater than or equal 95.5% to less than or equal 99.85%, or from greater than or equal 96% to less than or equal 99.8%, or from greater than or equal 96.5% to less than or equal 99.75%, or from greater than or equal 97% to less than or equal 99.7%, or from greater than or equal 97.5% to less than or equal 99.65%, or from greater than or equal 98% to less than or equal 99.6%, or from greater than or equal 98.5% to less than or equal 99.55%, or from greater than or equal 99% to less than or equal 99.5%, and all values and subranges therebetween.

In one or more embodiments, the deposits disposed within the honeycomb filter body are at a loading of less than or equal to 20 grams of the deposits per liter of the honeycomb filter body, or of less than or equal to 15 grams of the deposits per liter of the honeycomb filter body, or less than or equal to 10 grams of the deposits per liter of the honeycomb filter body, less than or equal to 7 grams of the deposits per liter of the honeycomb filter body, or less than or equal to 5 grams of the deposits per liter of the honeycomb filter body.

In some embodiments, an increase in pressure drop across the honeycomb due to the application of the deposits is less than 20% of the pressure drop of the uncoated honeycomb. In other embodiments that increase can be less than or equal to 9%, or less than or equal to 8%. In other embodiments, the pressure drop increase across the honeycomb body is less than or equal to 7%, such as less than or equal to 6%. In still other embodiments, the pressure drop increase across the honeycomb body is less than or equal to 5%, such as less than or equal to 4%, or less than or equal to 3%.

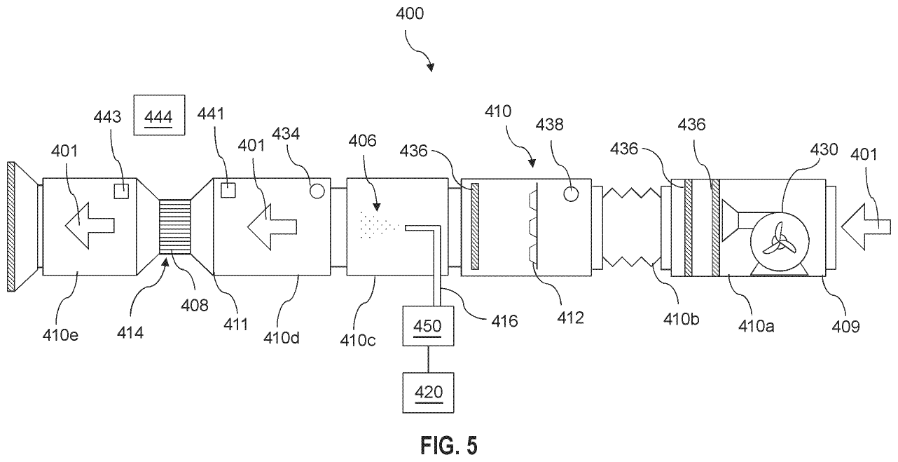

Referring now to FIG. 5, an embodiment of an apparatus 400 configured to apply inorganic particles 407 to a plugged honeycomb body 408 is shown. In one or more embodiments, the plugged honeycomb body is the type shown in FIGS. 2 and 3, and the plugged honeycomb body 408 comprises porous walls, an inlet end and an outlet end. The apparatus 400 shown in FIG. 5 comprises a duct 410 spanning from a first end 409 to a second end 411. The duct 410 can comprise a single unitary section of duct, or a plurality of duct sections 410a, 410b, 410c, and 410d as shown in FIG. 5. The plurality of duct sections 410a, 410b, 410c, and 410d can be joined together by collars or other suitable joining. One or more of the duct sections 410a, 410b, 410c, and 410d can comprise rigid duct material or flexible duct material.

The apparatus further comprises a deposition zone 414 configured to house the plugged honeycomb body 418 and to be in fluid communication with the second end 411 of the duct 410. An inlet conduit 416 is in fluid communication with the duct 410. In the embodiments shown, the inlet conduit 416 is located upstream from the deposition zone 414. In FIG. 5, the arrows 401 depict a direction of gas (e.g., air) flow through the apparatus 400, in particular through the duct 410, the deposition zone 414 and the plugged honeycomb body 408. The term “upstream” refers to a position or location in the apparatus that encounters flow before another position or location in the apparatus. Likewise, “downstream” refers to a position or location in the apparatus that encounters flow after another position or location in the apparatus. Thus, the first end 409 of the duct 410 encounters flow through the apparatus prior to the second end 411 of the duct 410, and the second end 411 of the duct 410 encounters flow through the apparatus prior to the deposition zone 114.

In the embodiment shown in FIG. 5, a inorganic particle source 420 is in fluid communication with the inlet conduit 416 and configured to supply inorganic particles 407 to the inlet conduit 416 and into the duct 410. An aerosol generator 214 comprising a Venturi tube 252 (as shown in FIG. 7) comprising a first end 251 and a second end 253 is in fluid communication with the inlet conduit 416. The aerosol generator 214 is configured to deliver an aerosol stream 406 comprising the inorganic particles 407 and gas (e.g., air) to the deposition zone 414.

Continuing with the embodiment shown in FIG. 5, a flow generator 430 is in fluid communication with the duct 410 and the deposition zone 414, the flow generator 430 being configured to establish a flow of a gas (e.g., air) and the inorganic particles 407 introduced into the duct 410 by the aerosol generator 214. Non-limiting examples of a flow generator 430 include a fan, a blower and/or a vacuum pump, which establishes a fluid flow, such as a gas flow (e.g., an air flow, nitrogen flow, or inert gas flow) in the direction of arrows 401.

In one or more embodiments, the aerosol generator 214 is configured to deliver a dry aerosol to the deposition zone 414. According to one or more embodiments, “dry aerosol” refers to an aerosol comprising a gas, such as air, and inorganic particles. In some embodiments, a dry aerosol consists essentially of inorganic particles and a gas, such as air, and no binder or added liquid is contained in the aerosol. In some embodiments, the dry aerosol can comprise a small amount of liquid or moisture, such as from ambient conditions, for example from 0.0001% to 5% by weight of the inorganic particle weight, from 0.0001% to 4% by weight, from 0.0001% to 3% by weight, from 0.0001% to 2% by weight, from 0.0001% to 1% by weight, from 0.0001% to 0.5% by weight, from 0.0001% to 0.4% by weight, from 0.0001% to 0.3% by weight, from 0.0001% to 0.2% by weight, from 0.0001% to 0.1% by weight, from 0.0001% to 0.01% by weight, or 0% liquid or moisture.

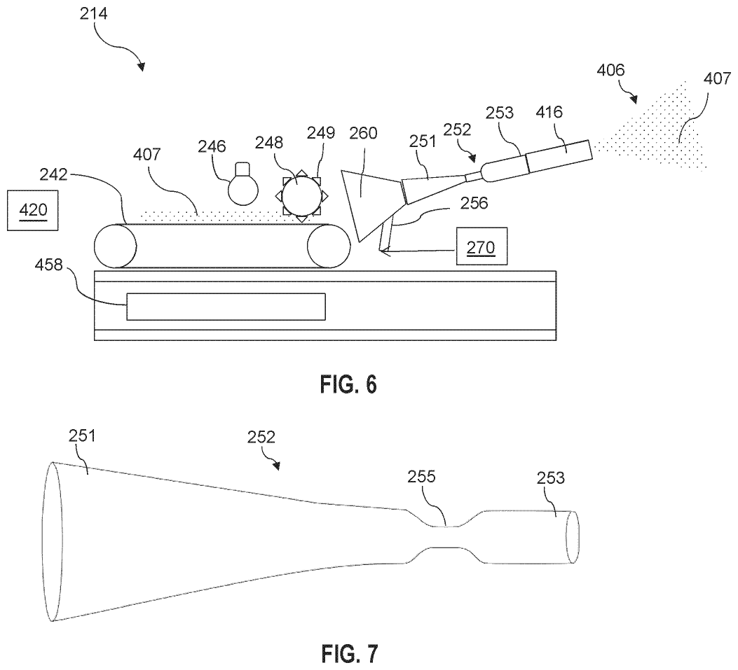

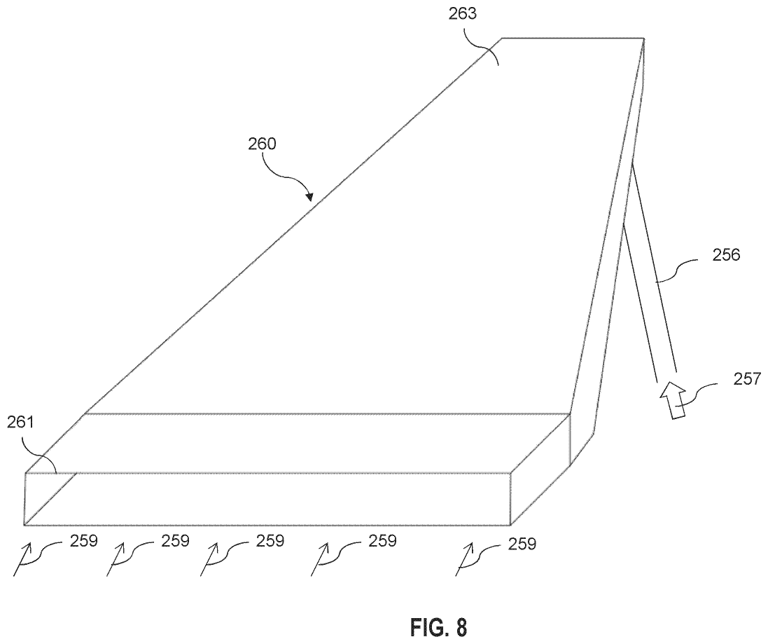

As shown in FIG. 6 and FIG. 8, the aerosol generator 214 further preferably comprises a delivery conduit 260 having a flared first end 261 configured to receive the inorganic particles 407 from the inorganic particle source 420. The delivery conduit 260 further comprises a second end 263 connected to the first end 251 of the Venturi tube 252, and a second end 253 of the Venturi tube 252 is connected to the inlet conduit 416. In the embodiment shown, the apparatus 400 further comprises pressurized gas source 270 in communication with the delivery conduit 260. In the embodiment shown, the pressurized gas source 270 can comprise a tank or cylinder of gas, such as air or nitrogen. The tank or cylinder can include a pressure regulator to regulate the flow of pressurized gas into a gas conduit 256. In some embodiments, the pressurized gas source 270 comprises an air compressor.

Referring now to FIG. 7, the Venturi tube 252 includes a reduced cross-sectional area portion 255 between the first end 251 and the second end of the Venturi tube. In a Venturi tube, when a fluid such as a gas and/or liquid or an aerosol comprised of a fluid such as a gas and/or liquid flows through the Venturi tube, a “Venturi effect” can be generated. The Venturi effect is the reduction in fluid pressure that results when a fluid or aerosol flows through a constricted section (or choke) of a pipe.

Referring back to FIG. 6, the aerosol generator 214 of the apparatus 400 further comprises a inorganic particle feed system 242 configured to deliver the inorganic particles 107 from the inorganic particle source 420 to the inlet conduit 416. The inorganic particles 407 from the inorganic particle source 420 in some embodiments are introduced to the delivery conduit by the inorganic particle feed system 242, which in the embodiment shown is a conveyor. The inorganic particle feed system 242 according to one or more embodiments comprises a gravity feed system, a screw auger, a belt conveyor, a chain conveyor, or other suitable device to introduce the inorganic particles 407 to the delivery conduit 260.

FIG. 8 shows an isometric view of the delivery conduit 260 according to one or more embodiments. The high pressure flow of gas indicated by arrow 257 through the gas conduit 256 causes gas to flow through the flared end 261 of delivery conduit 260 as shown by arrows 259 adjacent the flared end 261. This flow of gas indicated by arrows 259 entrains, draws up or sucks up particles 407 from inorganic particle feed system 242 into the flared end 261 of the delivery conduit 260 and out the second end 263 of the delivery conduit 260. The inorganic particles 407 then enter the Venturi tube 252 wherein the particles are mixed with gas and form an aerosol 406 comprised of the inorganic particles 407 and the gas, and the aerosol 406 is delivered into the duct 410 at duct section 410c through the inlet conduit 416. The flow of gas (e.g., air) in the duct 410 indicated by arrows 401 causes the aerosol 406 comprising the inorganic particles 407 in the duct 410 to be transported to the plugged honeycomb body 408 located in the deposition zone. Gas flows through the plugged honeycomb body and into an exit duct section 410.

In the embodiment shown in FIG. 5 and FIG. 6, the apparatus further preferably includes a drying apparatus 246 configured to dry the inorganic particles 407. In the embodiment shown, the drying apparatus 246 is positioned upstream from the delivery conduit 260. The aerosol generator 214 according to one or more embodiments can further comprise an agglomerate reducing device, which in the embodiment shown is a roller 248 having ridges 249 on the outer periphery of the roller to break up or pulverize agglomerates and reduce agglomerates of the inorganic particles 407 before being drawn or sucked into the delivery conduit 260. The roller 248 is positioned upstream from the delivery conduit 260. In the embodiment shown, flow generator 430 is positioned at the inlet end 409 of the duct 410 and upstream from the inlet conduit 416. In some embodiments the flow generator is positioned in or adjacent the exit duct section 410e, and gas (e.g., air) flow can be generated in the same direction shown by arrows 101 by directing the fan to draw or suck air through the duct 410.

When high pressure air is forced into the delivery conduit, lightweight inorganic particles at the entrance of the delivery conduit are inhaled due to the negative pressure created by Venturi effect. The aerosol is sheared and exits the Venturi tube into the duct 410. When the aerosol is delivered into the duct 410, the gas volume expands and the flow speed of the inorganic particles 407 is rapidly reduced. The aerosol is then dispersed and carried through the duct 410 preferably by laminar air flow provided by the flow generator 430. The inorganic particles 407 are directed into and onto the porous walls of the plugged honeycomb body. According to some embodiments of the present disclosure, no heat is required to post-treat the honeycomb body after deposition of the inorganic particles; in other embodiments the honeycomb body, and more particularly the inorganic particles, are heat treated, such as to sinter or cure or otherwise adhere the inorganic particles to the porous wall structure.

Embodiments of the apparatus further preferably comprise a homogenizer plate 412 configured to homogenize flow of gas through the duct 410. One or more filters 436, for example HEPA filters are preferably positioned in sections of the duct 410 to filter particles from the gas drawn through the duct by the flow generator 430.

In some embodiments, the apparatus 400 further preferably comprises a first pressure sensor 441 located upstream from the deposition zone 414 and a second pressure sensor 443 positioned downstream from the deposition zone 414. The apparatus of some embodiments further preferably comprises a humidity sensor 438 and a mass flow controller 434. The first pressure sensor 441 and the second pressure sensor 443 are in some embodiments in communication with a processor 444 which measures a differential pressure between the first pressure sensor 441 and the second pressure sensor 443. In one or more embodiments, the processor 444 can be integral with and/or wired to the first pressure sensor 441 and the second pressure sensor 443, or separate from the first pressure sensor 441 and the second pressure sensor 443. The humidity sensor 438 and the mass flow controller in some embodiments are in communication with the processor 444. In some embodiments the processor 444 comprises includes a central processing unit (CPU), a memory, and support circuits. The processor 444 can be a general-purpose computer processor that can be used in an industrial setting monitoring pressure and calculating a pressure differential between pressure sensors. The memory, or computer readable medium of the processor 444 can be one or more of readily available memory such as random access memory (RAM), read only memory (ROM), floppy disk, hard disk, optical storage media (e.g., compact disc or digital video disc), flash drive, or any other form of digital storage, local or remote. The support circuits are coupled to the CPU for supporting the processor 444. These circuits include cache, power supplies, clock circuits, input/output circuitry and subsystems. One or more processes can be stored in the memory as a software routine that can be executed or invoked to control the operation of the first pressure sensor 441 and the second pressure sensor 443 in the manner described herein. In some embodiments, the processor 444 receives readings from the mass flow controller and the humidity sensor 438, and the processor 444. A control panel 458 on the aerosol generator 214 is also in communication with the processor 444.

Another aspect of the disclosure pertains to a method of applying inorganic particles to a plugged honeycomb body comprising intersecting porous walls extending from an inlet end to an outlet end of the body and defining axial channels, wherein some of the channels are plugged, the method comprising aerosolizing a plurality of inorganic particles having a particle d50 of between 10 nm and 500 nm, depositing the particles on, in, or both on and in, the porous walls of the plugged honeycomb body, and fusing at least some of the particles to each other and to the plugged honeycomb body. In one or more embodiments the method is performed in the apparatus shown in FIGS. 5-8.

In some embodiments, the mineral particles have a D50 particle size distribution falling in the range of from 10 to 600 nm, from 10 to 500 nm, or from 50 to 500 nm.

One or more embodiments of the method further comprise introducing a flow of air through the duct. This can be accomplished using the flow generator shown in FIG. 5, for example a fan, a blower or a vacuum. In some embodiments, a flow generator in fluid communication with the duct and the plugged honeycomb body is used to generate a flow of inorganic particles mixed with the flow of air. Embodiments of the method preferably include flowing the flow of air through a homogenizer plate, for example the homogenizer plate 412.

In some embodiments, the method further comprises optionally drying the inorganic particles prior to flowing the inorganic particles through the Venturi tube, for example with the drying apparatus 246 shown in FIG. 6. As shown in FIG. 6, the Venturi tube 252 is in communication with a pressurized gas source 270. For example, in some method embodiments, the pressurized Venturi tube 252 with the inlet conduit 416 positioned upstream from the plugged honeycomb body 408, and the pressurized air source 270 is connected to the delivery conduit 260.

Embodiments of the method further comprise reducing inorganic particle agglomerates prior to flowing the inorganic particles to the Venturi tube. As described above, the agglomerates are reduced in some embodiments using a roller 248. Some embodiments of the method further comprise measuring pressure upstream and downstream from the plugged honeycomb body.

In exemplary embodiments, the inorganic particle feed system 242 comprises a chain conveyor having four speed modes ranging from 1.25 to 4.0 cm/min, to precisely control the rate of inorganic particle loading. In some embodiments, a plurality of homogenizer plates 112 can be provided, which can be in the form of orifice plates inside the duct to provide for flow lamination and uniformity. In a specific embodiment, there are four homogenizer plates in the duct 110. Temperature and humidity monitors and pressure sensors provide a way to monitor the running conditions. In specific embodiments, the compressed air pressure was 3.0 bar, the roller was rotated at rate of 2.7-3.3 revolutions per minute and the chain conveyor speed was varied between 1.25 and 4.0 cm/min. The flow generator provided an air flow rate ranging from 10 to 40 Nm³/hour in a square duct that was 7 meters in length between the flow generator to the exhaust duct section 110e.

According to one or more embodiments, GPF filters can be modified with a surface treatment by depositing inorganic particles onto and/or into the walls channels of a GPF filter or filter body. As the particles form a deposit on the inlet channels of the filter they act to occupy pores in the microstructure of the channel walls. During the build-up of the particles the initial (essentially clean) filtration efficiency of the filter increases from its base value (˜50%) to a much higher values, even greater than 90%.

In some embodiments, the particles comprise one or more of low melting glass particles, cement particles, binder-coated mineral particles, or combinations thereof.

In some embodiments, the mineral particles comprise particles of calcium carbonate, kaoline, wollastonite, talcum powder, mica powder, silica powder, brucite powder, pyrophyllite, coal ash, dolomite, sepiolite, or combinations thereof.

In one or more embodiments, the particles have a average primary particle size in a range of from about 10 nm to about 4 micrometers, about 20 nm to about 3 micrometers or from about 50 nm to about 2 micrometers, or from about 50 nm to about 900 nm or from about 50 nm to about 500 nm. In specific embodiments, the average primary particle size is in a range of from about 100 nm to about 200 nm, for example, 150 nm.

In some embodiments, the aerosolizing comprises passing a suspension of the inorganic particles and a carrier fluid through a venturi tube.

In some embodiments, the aerosolizing generates a dry aerosol stream containing the inorganic particles.

In some embodiments, the carrier fluid is a gas.

In some embodiments, the carrier fluid is an essentially dry gas.

In some embodiments, the carrier fluid is a liquid.

In some embodiments, the carrier fluid comprises a liquid, a gas, or a combination thereof.

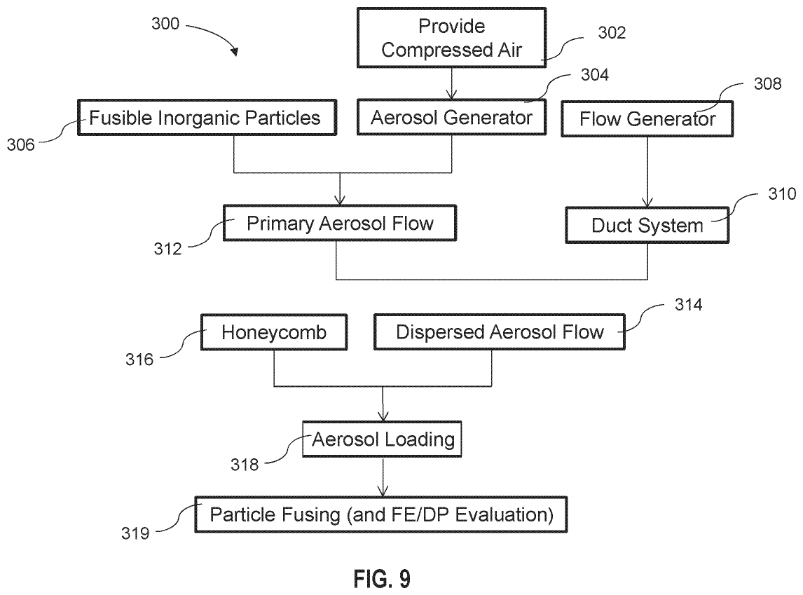

FIG. 9 shows a flow diagram of components of some method embodiments. Method 300 comprises providing compressed gas such as compressed air at 302. The compressed air is flowed to an aerosol generator at 304 as described above. Inorganic particles are supplied to the aerosol generator at 306. At 308 a flow generator is placed in flow or fluid communication with a duct system as described with respect to FIG. 5. Aerosol flow is established by the aerosol generator at 312. The flow of gas such as air provides a dispersed aerosol flow at 314 in the duct system 110. A plugged honeycomb body provided at 316 is contacted with the dispersed aerosol flow, causing aerosol loading at 318. The deposited particles and then fused at least in part to each other and to the honeycomb body at 319, and Filtration efficiency (FE) and different pressure DP can then be evaluated if and as desired.

### Example 1

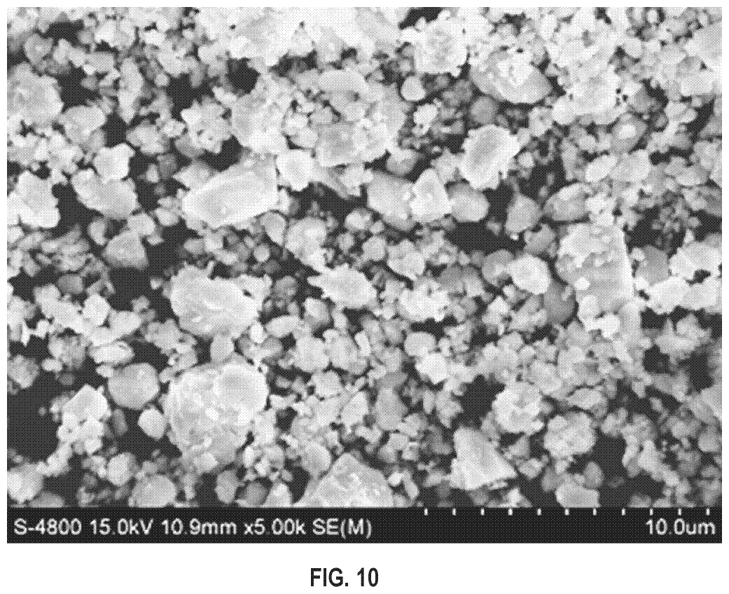

An apparatus similar to that shown and described with respect to FIGS. 5-8 was employed to perform inorganic particle loading of a plugged honeycomb body using particles of a Bi₂O₃—SiO₂—ZnO—B₂O₃ based low melting glass composition (˜430° C. softening point) of 3 micrometer D50 size distribution. The particles were carried and blown into a wind tunnel using compressed air. The diluted aerosol was captured by a filter body and accumulated gradually to form the desired deposits, the morphology of which is shown in the SEM image of FIG. 10.

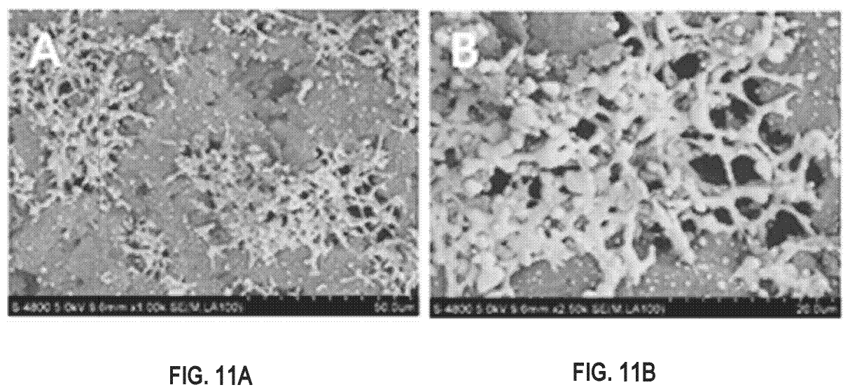

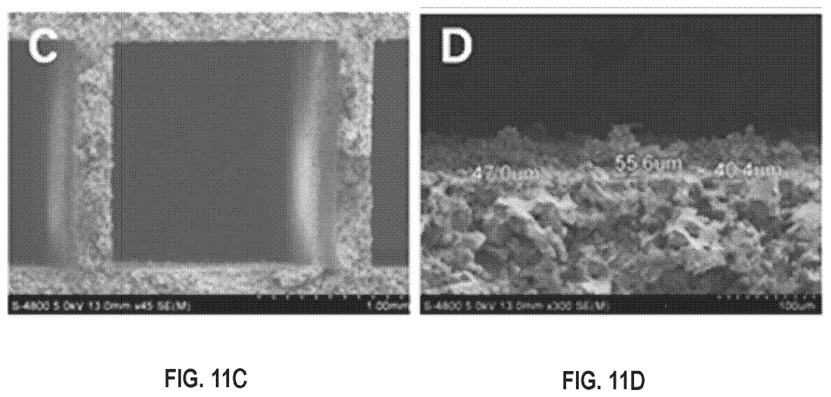

After the particles were deposited onto the walls of the plugged honeycomb body, the particles were partly fused to each other and to the honeycomb body by sintering at 440° C. for 45 minutes. During sintering, the glass particles softened and melted together and formed a net structure, as shown in the SEM images of FIGS. 11A and 11B. From the cross-section images in FIGS. 11C and 11D, the thickness of the deposited layer was in the range of about 40 to 60 m on the side wall and thicker near the corner.

Liquid phase aerosol of DEHS (DiEthyHexylSebacate) size of was produced using a Laskin nozzle arrangement so as to create with aerosol particles of size in the range of about 0.3 to 1 micrometers. Air with the test particles suspended therein was flowed through the filter body at a speed of about 1 m/s. Image based particle counts were performed before and after a bare filter body, an as-deposited (but before sintering) filter body, and after sintering filter body, and an after regeneration filter body. (Regeneration comprised a water flush regeneration using water flush at a pressure of 0.3 MPa for 30 seconds.) Back pressure was also measure for each of these conditions of the filter body.

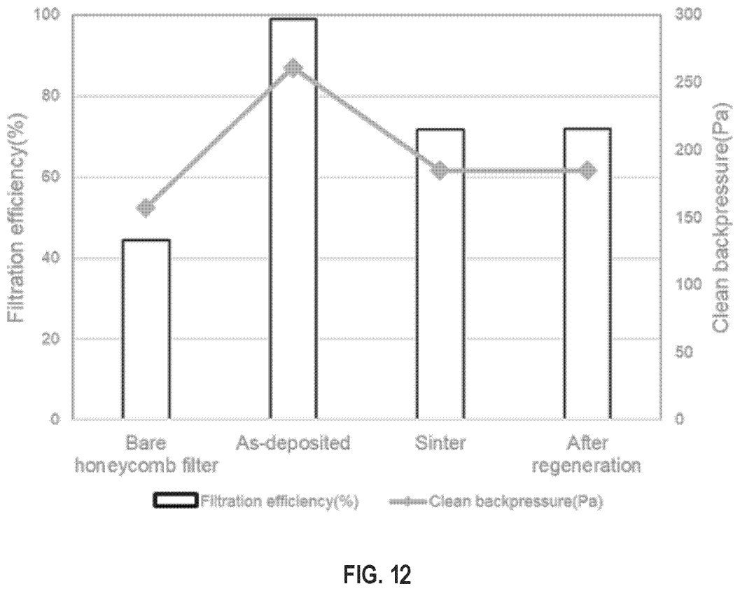

Results are shown in FIG. 12. As seen in the figure, the sintered “porosity net” structure as shown in FIGS. 11A and 11B provided improved filtration efficiency compared to the bare honeycomb filter of 71.78% vs. 44.35%. The glass particles softened during the sinter process and fused to the honeycomb wall and also to each other. This results in the water wash resistance property of the deposits. As shown in the figure, after regeneration the filtration efficiency of the filter body was 71.84%, demonstrating that the filter body with the deposits or “membrane” is washable, with no filtration efficiency reduction on regeneration.

If desired, as-sintered filtration efficiency can more nearly approach the as-deposited filter efficiency by use of finer particles and/or by optimizing the sintering time and temperature. In one variation, sinter temperature was lowered to 410° C., and sinter time was extended to 1.5 hours. The resulting filter body tested as described above achieved 90% filter efficiency after sintering, and 85% after regeneration, yielding a small reduction of 5% on regeneration.

Other variations were conducted with mineral particles (CaCO₃) in different amounts mixed with the glass particles. Some decrease in filter efficiency after regeneration was seen, but an improvement over pure CaCO₃ was achieved.

### Example 2

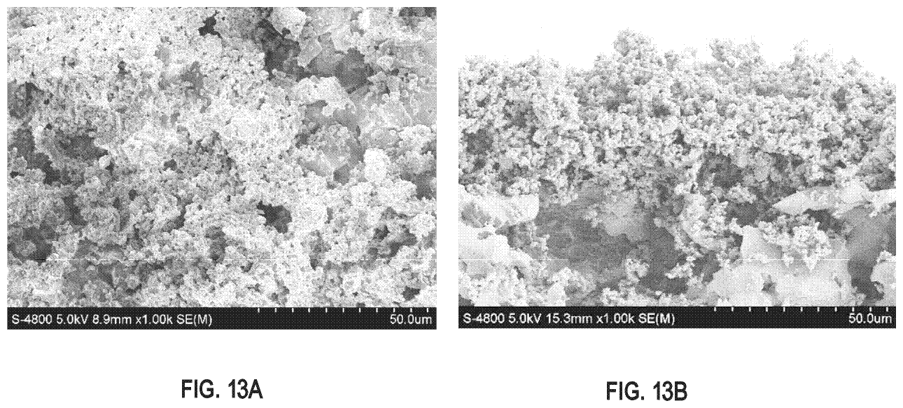

A filter body was prepared as in Example 1 but using cement powder particles with of size 4.34 micrometer D50 size as the inorganic particles for deposition. The particles were then fused in part to each other and/or to the filter body by curing at 70% humidity and 70° C. for 48 hours. FIGS. 13A and 13B are SEM images showing the morphology of the particles after deposition and curing. After the cure in the thermal-humidity chamber, the cement powder cohered together and formed the net structure seen in the figures. The thickness of cured deposits was in the range of about 20 to 60 micrometers.

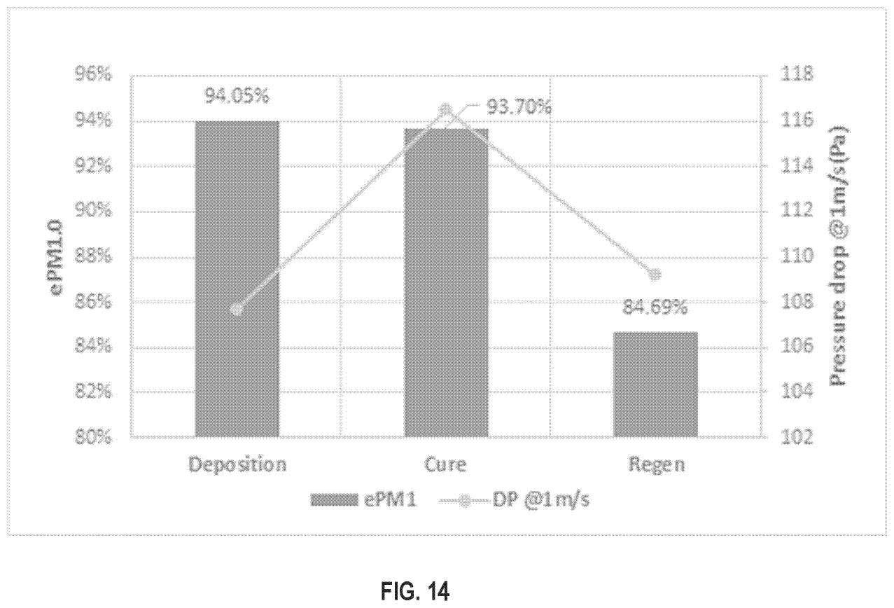

The same testing as in Example 1 was performed. The results (except for the bare filter body) are shown in FIG. 14. The porosity net structure produced after cure as shown in FIGS. 13A and 13B provided efficiency of 93.7%, compared to only 44.35% for the bare honeycomb filter. The cement successfully cured under elevated humidity and temperature conditions, and maintained the cured structure over time. During the cure process, the cement powder particles were physically and/or chemically fused to the honeycomb filter substrate and to each other. This produced good water resistance shown by the regeneration test in which the filtration efficiency of the filter body was 84.69%, demonstrating that the filter body and the deposits or the “membrane” is reasonably washable. It is believed that optimizing the curing time and conditions will increase the post-regeneration filtration efficiency.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics can be combined in any suitable manner in one or more embodiments.

Although the disclosure herein has been described with reference to particular embodiments, those skilled in the art will understand that the embodiments described are merely illustrative of the principles and applications of the present disclosure. It will be apparent to those skilled in the art that various modifications and variations can be made to the method and apparatus of the present disclosure without departing from the spirit and scope of the disclosure. Thus, the present disclosure can include modifications and variations that are within the scope of the appended claims and their equivalents.

1. A filtration article comprising:
a plugged honeycomb filter body;
deposits of inorganic particles within the plugged honeycomb filter body, the deposits having a porosity in a range of greater than 95% to less than or equal to 99.9% and an average thickness in a range of greater than or equal to 0.5 μm to less than or equal to 200 μm; and
at least some of the inorganic particles being fused to each other or to the filter body.

2. The filtration article of claim 1 wherein the filtration article has a clean filtration efficiency of greater than or equal to 80% as measured by a liquid phase aerosol filtration efficiency test, and a decrease of filtration efficiency after a water flush regeneration of less than 10% measured by the liquid phase aerosol filtration efficiency test.

3. The filtration article of claim 1 wherein the filter body is comprised of cordierite, aluminum titanate, enstatite, mullite, forsterite, corundum, spinel, sapphirine, and periclase, or combinations thereof.

4. The filtration article of claim 1 wherein the filter body is comprised of cordierite.

5. The filtration article of claim 1 wherein the at least some of the inorganic particles are fused to each other and/or to the filter body by one or more of (1) inorganic fusion bonding between at least some of the inorganic particles by fusion bonds formed by low-melting inorganic particles constituting at least some of the inorganic particles, (2) inorganic chemical bonding between at least some of the inorganic particles by chemical bonds formed by inorganic particles capable of chemical bonding constituting at least some of the inorganic particles, and (3) organic fusion bonds or organic chemical bonds between inorganic particles with the bonds formed by an organic coating on inorganic particles constituting at least some of the inorganic particles.

6. The filtration article of claim 5 wherein the inorganic particles comprise particles of low melting glass and other inorganic particles.

7. The filtration article of claim 6 wherein the other inorganic particles comprise mineral particles.

8. The filtration article of claim 5 wherein the inorganic particles consist essentially of particles of low melting glass.

9. The filtration article of claim 5 wherein the inorganic particles comprise particles of cement and other inorganic particles.

10. The filtration article of claim 9 wherein the other inorganic particles comprise mineral particles.

11. The filtration article of claim 5 wherein the inorganic particles consist essentially of particles of cement.

12. The filtration article of claim 5 wherein the inorganic particles comprise inorganic particles coated with an inorganic binder and other inorganic particles.

13. The filtration article of claim 12 wherein the other inorganic particles comprise mineral particles.

14. The filtration article of claim 5 wherein the inorganic particles consist essentially of inorganic particles coated with an inorganic binder.

15. The filtration article of claim 1, wherein the deposits disposed within the plugged honeycomb filter body are present at a loading of greater than 0.05 and less than or equal to 20 grams of the deposits per liter of the plugged honeycomb filter body.

16. The filtration article of claim 1, wherein the inorganic particles comprise one or more of low melting glass particles, cement particles, binder-coated mineral particles, or combinations thereof.

17. The filtration article of claim 16, wherein the mineral particles comprise one or more of calcium carbonate, kaoline, wollastonite, talcum powder, mica powder, silica powder, brucite powder, pyrophyllite, coal ash, dolomite, sepiolite, or combinations thereof.

18. The filtration article of claim 1, wherein the inorganic particles have a D50 particle size distribution in the range of from 50 to 500 nm.

19. A method of applying inorganic particles to a plugged honeycomb body comprising intersecting porous walls extending from an inlet end to an outlet end of the body and defining axial channels, wherein some of the channels are plugged, the method comprising:
aerosolizing a plurality of inorganic particles having a particle d50 of between 10 nm and 500 nm,
depositing the particles on, in, or both on and in, the porous walls of the plugged honeycomb body, and
fusing at least some of the particles to each other and to the plugged honeycomb body.

20. The method of claim 19 wherein the particles comprise one or more of low melting glass particles, cement particles, binder-coated mineral particles, or combinations thereof.

21. The method of claim 19 wherein the mineral particles comprise particles of calcium carbonate, kaoline, wollastonite, talcum powder, mica powder, silica powder, brucite powder, pyrophyllite, coal ash, dolomite, sepiolite, or combinations thereof.

22. The method of claim 19 wherein the aerosolizing comprises passing a suspension of the inorganic particles and a carrier fluid through a venturi tube.

23. The method of claim 19 wherein the aerosolizing generates a dry aerosol stream containing the inorganic particles.

24. The method of claim 19 wherein the carrier fluid is a gas.

25. The method of claim 24 wherein the carrier fluid is an essentially dry gas.

26. The method of claim 19 wherein the carrier fluid is a liquid.

27. The method of claim 19 wherein the carrier fluid comprises a liquid, a gas, or a combination thereof.
